(19) United States
(12) Patent Application Publication
(10) Pub. No.: US 2026/0314690 A1
(43) Pub. Date: Oct. 15, 2026

(54) ATOMIZATION DEVICE, CONTROL SYSTEM AND CONTROL METHOD FOR ATOMIZATION DEVICE

(71) Applicant: SHENZHEN SKE TECHNOLOGY CO.,LTD., SHENZHEN (CN)

(72) Inventors: ZHENYU HUANG, SHENZHEN (CN); PINGFAN MIN, SHENZHEN (CN); LUN WU, SHENZHEN (CN)

(21) Appl. No.: 19/454,308

(22) Filed: Jan. 20, 2026

(30) Foreign Application Priority Data
Apr. 10, 2025 (CN) 202510451290.X
Sep. 8, 2025 (CN) 202511274739.6

(51) Int. Cl. A24F 40/485; A24F 40/53; F16K 31/06; A24F 40/10

(52) U.S. Cl. CPC A24F 40/485; A24F 40/53; F16K 31/0668; F16K 31/0675; A24F 40/10

(57) ABSTRACT

An atomization device is provided, which includes a fluid reservoir defined with a release port, and a magnetic fluid valve configured to close or open the release port. The magnetic fluid valve includes a magnetic field generator and a movable mechanism movable relative to the magnetic field generator. The movable mechanism includes a magnetic movable component and a retainer. The magnetic movable component includes a sealing member configured to move between a first position for closing the release port and a second position for opening the release port and a magnet drive the sealing member to move between the first position and the second position. The magnetic field generator is configured to generate a magnetic field acting on the magnet. The magnetic field generator includes an initial state and a use state.

### TECHNICAL FIELD

The present disclosure relates to the technical field of electronic atomization apparatus, and in particular, to an atomization device, and a control system and a control method for an atomization device.

### BACKGROUND

An atomization device, also referred to as an electronic atomization device, is commonly used for medical nebulization therapy or as a cigarette substitute. It mainly includes an atomization assembly and a power supply component. The atomization assembly includes a fluid reservoir and an atomization core. The fluid reservoir supplies the fluid (i.e., the atomization substrate or e-liquid) required for aerosol generation to the atomization core. When energized by power supply component, the atomization core heats the atomization substrate to produce aerosol. In the related art, fluid may be supplied actively or passively. For active supplying, fluid is continuously supplied from the fluid reservoir to the atomization core through a release port defined in the fluid reservoir. For passive supplying, an operable movable mechanism is used to close or open the release port.

The movable mechanism includes an electromagnet, an elastic member, and a sealing member. The sealing member seals the release port by way of elastic force from the elastic member and opens the release port under the magnetic force generated by the electromagnet, thereby achieving control over the release of fluid from the fluid reservoir. During continuous use, the elastic member is subject to operational fatigue, as the elastic force decreases, the sealing strength of the sealing member against the release port is reduced.

### SUMMARY

The present disclosure provides an atomization device, and a control system and a control method for the atomization device, to improve the sealing performance of the sealing member against the release port.

According to a first aspect, the present disclosure provides an atomization device, including a fluid reservoir and a magnetic fluid valve. The fluid reservoir is defined with a release port for releasing fluid to outside, the magnetic fluid valve is configured to close or open the release port, and the magnetic fluid valve includes:
a magnetic field generator and a movable mechanism configured to move relative to the magnetic field generator, the movable mechanism including a magnetic movable component and a retainer, and the magnetic movable component including:
a sealing member, configured to move between a first position for closing the release port and a second position for opening the release port; and
a magnet, configured to drive the sealing member to move between the first position and the second position under the action of an external magnetic force, the magnet having a first magnetic pole close to the release port and a second magnetic pole away from the release port, wherein the first magnetic pole and the second magnetic pole have opposite polarities;
wherein the retainer is configured to provide a force for retaining the sealing member at the first position; and
the magnetic field generator is configured to generate a magnetic field acting on the magnet, and the magnetic field generator includes an initial state and a use state;
in the initial state, the magnetic field generator is capable of, when energized, generating a magnetic field that attracts the second magnetic pole of the magnet, to drive the movable mechanism to move close to the first position or maintain the movable mechanism at the first position; or the magnetic field generator is not energized, and the retainer is configured to provide the force to keep the magnetic field generator at the first position; and
in the use state, the magnetic field generator is capable of, when energized, generating a magnetic field that attracts the first magnetic pole of the magnet, to drive the movable mechanism to move from the first position to the second position.

In some embodiments, the sealing member is made of a deformable material, and at least a portion of the sealing member is fixed to a side of the magnet close to the release port.

In some embodiments, the retainer is a spring, and the magnetic field generator is a conductive coil or an electromagnet.

In some embodiments, the movable mechanism is disposed inside the fluid reservoir, the sealing member is located at a side of the magnet close to the release port, the retainer is disposed between an inner wall of the fluid reservoir and the magnet or between an inner wall of the fluid reservoir and the sealing member, and the magnetic field generator is disposed outside the fluid reservoir.

In some embodiments, the sealing member encloses the magnet, and a surface of the sealing member in contact with the fluid reservoir is provided with a plurality of spaced-apart ribs.

In some embodiments, an interior of the fluid reservoir is divided into a fluid accommodation cavity and an installation cavity by a partition, the installation cavity is defined with an opening at a side close to the release port, the movable mechanism is disposed in the installation cavity, and the sealing member, when in the first position, at least partially extends through the opening and closes the release port; and the atomization device further includes a bracket disposed outside the fluid reservoir, and the magnetic field generator is fixed on the bracket.

In some embodiments, the atomization device further includes a battery and a circuit board connected to the battery; the first magnetic pole is downward, the second magnetic pole is downward, and the magnetic field generator is fixed below the fluid reservoir, the magnetic field generator is an electromagnet connected to the circuit board. When the electromagnet is energized with a current in a first direction, a first induced magnetic pole is generated at an upper end of the electromagnet, to drive the magnetic movable component to move from the first position to the second position, wherein a polarity of the first induced magnetic pole is opposite to a polarity of the first magnetic pole and is the same as a polarity of the second magnetic pole. When the electromagnet is energized with a current in a second direction, a second induced magnetic pole is generated at the upper end of the magnetic field generator, to drive the magnetic movable component to move from the second position to the first position, wherein a polarity of the second induced magnetic pole is opposite to the polarity of the second magnetic pole and is the same as the polarity of the first magnetic pole. The second direction is opposite to the first direction.

In some embodiments, the magnetic field generator is an electromagnet, the first magnetic pole and the second magnetic pole are integrally arranged or separately arranged, and the electromagnet is located directly below the magnetic movable component; and when the sealing member is in the first position, a magnetic axis of the magnet is located between a central axis of the electromagnet and the release port; and when the sealing member is in the second position, the central axis of the electromagnet is located between the magnetic axis of the magnet and the release port; where the magnetic axis of the magnet is located at a center between the first magnetic pole and the second magnetic pole, and the central axis of the electromagnet is located at a center of the magnetic field generated by the electromagnet.

According to a second aspect, the present disclosure provides a control system for an atomization device. The atomization device is the atomization device of any one of the foregoing embodiments, and the atomization device further includes an atomization assembly communicated with the fluid reservoir through the release port. The control system includes:
a main control module, the main control module being preset with a timeout forced-closure duration and a post-inhalation cumulative opening count for the release port, wherein the timeout forced-closure duration refers to a time period from an initial opening of the release port until the release port is required to be forcibly closed, and the post-inhalation cumulative opening count refers to the number of additional openings required for the release port after that inhalation ends; the main control module being electrically connected to the atomization assembly, and configured to control the atomization assembly to perform atomization; and the main control module being further electrically connected to the magnetic fluid valve, and further configured to control the magnetic fluid valve to open or close the release port, and to control the magnetic fluid valve to forcibly close the release port;
a detection module connected to the main control module, the detection module being configured to send an electrical signal to the main control module in response to detecting an inhalation action;
a timeout detection module connected to the main control module, the timeout detection module being configured to start timing when the main control module controls the magnetic fluid valve to open the release port, and the timeout detection module being further configured to send a signal to the main control module when a timing duration reaches the timeout forced-closure duration, to allow the main control module to control the magnetic fluid valve to forcibly close the release port;
a counting module connected to the main control module, the counting module being configured to, after inhalation ends, obtain a remaining number of openings required for the release port and sends the remaining number of openings to the main control module, to allow the main control module to control the magnetic fluid valve to open or close the release port based on the remaining number of openings;
wherein the remaining number of openings equals the post-inhalation cumulative opening count minus the number of times that the release port has already been opened after inhalation ends; and
a power supply module connected to the main control module.

According to a third aspect, the present disclosure provides a control method for an atomization device. The atomization device is the atomization device of any one of the foregoing embodiments, the atomization device further includes an atomization assembly communicated with the fluid reservoir through the release port, and the control method includes:

S1: powering on the atomization device;

S2: detecting whether there is an inhalation action; in response to detecting an inhalation action, controlling the magnetic fluid valve to open the release port to allow e-liquid in the fluid reservoir to enter the atomization assembly through the release port, and controlling the atomization assembly to perform atomization; and after the release port remains open for a third duration, controlling the magnetic fluid valve to close the release port;

S3: continuously detecting whether there is an inhalation action; in response to detecting an inhalation action, controlling the atomization assembly to continue atomization; and in response to detecting no inhalation action, controlling the atomization assembly to stop atomization;

S4: if no inhalation action is detected for a duration reaching a first duration, determining that inhalation ends, and performing step S5;

S5: in response to determining that the remaining number of openings required for the release port after that inhalation ends equals to zero, controlling the atomization device to power off; and in response to determining that the remaining number of openings required for the release port after that inhalation ends is not equal to zero, performing step S6; wherein the remaining number of openings required for the release port after inhalation equals to a post-inhalation cumulative opening count minus the number of times that the release port has already been opened after inhalation, and the post-inhalation cumulative opening count is a preset value; and

S6: controlling the magnetic fluid valve to open the release port for a second duration, then controlling the magnetic fluid valve to close the release port, and incrementing the number of times that the release port has already been opened after that inhalation ends by one; and returning to step S5.

According to the present disclosure, the magnetic field generator releases a controllable magnetic field to act on the magnet, thereby driving the magnet and, consequently, the sealing member to move between the first position that closes the release port and the second position that opens the release port.

### BRIEF DESCRIPTION OF THE DRAWINGS

To illustrate the technical solutions in the embodiments of the present disclosure more clearly, the following briefly introduces the accompanying drawings required for describing the embodiments of the present disclosure. Apparently, the accompanying drawings in the following description are only some embodiments of the present disclosure, and those skilled in the art may obtain other drawings based on these accompanying drawings without creative efforts.

FIG. 1 is a schematic structural diagram of a magnetic fluid valve according to an embodiment of the present disclosure, wherein the magnetic fluid valve is in a first position where it closes the release port.

FIG. 2 is a schematic diagram of a magnetic fluid valve in a second position where it opens the release port according to an embodiment of the present disclosure.

FIG. 3 is a schematic partial structural diagram of an atomization device according to an embodiment of the present disclosure.

FIG. 4 is a cross-sectional schematic structural diagram of an atomization device according to an embodiment of the present disclosure.

FIG. 5 is a top view of the atomization device of FIG. 4.

FIG. 6 is a schematic structural diagram of a bottom of a sealing member according to an embodiment of the present disclosure.

FIG. 7 is a structural diagram of an atomization device according to an embodiment of the present disclosure.

FIG. 8 is a schematic diagram showing a release port in a closed state according to an embodiment of the present disclosure.

FIG. 9 is a schematic diagram showing a release port in an open state according to an embodiment of the present disclosure.

FIG. 10 is a schematic diagram showing a release port in a forced-closed state according to an embodiment of the present disclosure.

FIG. 11 is a block diagram of a control system for an atomization device according to an embodiment of the present disclosure.

FIG. 12 is a logic diagram of a control system for an atomization device according to an embodiment of the present disclosure.

FIG. 13 is a logic diagram showing operation of a timeout detection module according to an embodiment of the present disclosure.

The realization of the objectives, functional features, and advantages of the present disclosure will be further described in conjunction with the embodiments and with reference to the accompanying drawings.

### DETAILED DESCRIPTION OF THE EMBODIMENTS

The technical solutions in the embodiments of the present disclosure will be described clearly and completely with reference to the accompanying drawings in the embodiments of the present disclosure. Obviously, the described embodiments are only a part of the embodiments of the present disclosure rather than all of them. Based on the embodiments in the present disclosure, all other embodiments obtained by those skilled in the art without creative work shall fall within the scope of protection of the present disclosure.

It should be noted that all directional indications (such as up, down, left, right, front, back) in the embodiments of the present disclosure are merely used to explain relative position relationships or motion conditions between the components in a specific attitude (as shown in the drawings). The directional indication changes as the specific attitude changes.

Moreover, the terms “first”, “second”, and the like in the present disclosure are merely used for description and cannot be understood as indicating or implying their relative importance or as implicitly indicating the quantity of the technical features indicated. Thus, the feature defined by “first” or “second” may explicitly or implicitly include at least one such feature. In addition, the technical solutions of various embodiments may be combined with each other, but must be based on that the combined technical solutions can be implemented by those skilled in the art. When the combination of the technical solutions is contradictory or impossible to realize, it shall be considered that such combination does not exist and is not within the scope of protection of the present disclosure.

Atomization devices are commonly used in medical nebulization, cosmetic atomization, electronic cigarettes, and the like. The present disclosure takes an electronic cigarette that generates aerosol by heating an atomization substrate as an example. The electronic cigarette mainly includes a fluid reservoir, an atomization chamber, and an atomization core. The fluid reservoir supplies the fluid (i.e., the atomization substrate or e-liquid) required for aerosol generation to the atomization core through a release port. The atomization core is disposed within the atomization chamber and, when being energized, heats the atomization substrate to generate aerosol. A power supply component provides the electrical energy required for the atomization core to generate heat.

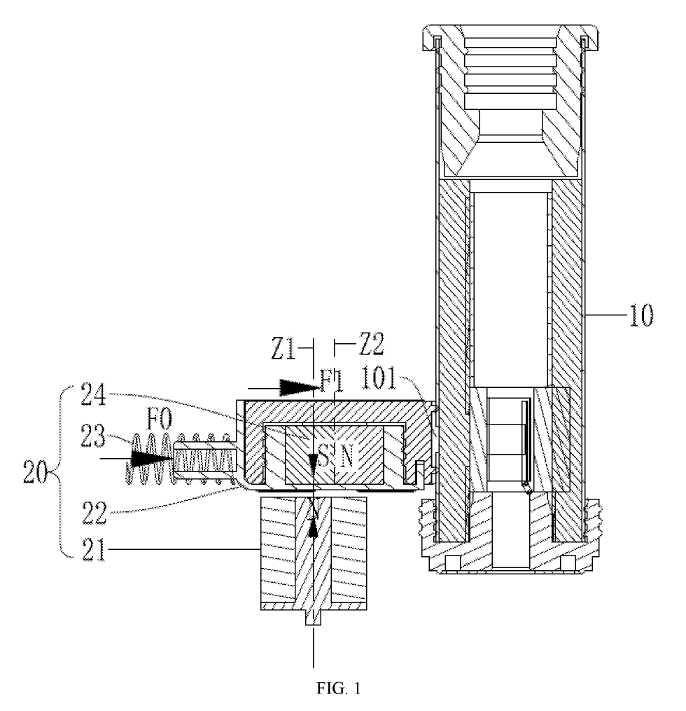

With reference to FIG. 1 to FIG. 6, the present disclosure provides a magnetic fluid valve 20, which is configured to close or open a release port 101 of an atomization device 1 that is communicated with an atomization chamber of the atomization device 1. The magnetic fluid valve 20 includes a magnetic field generator 21 and a movable mechanism 27 that is movable relative to the magnetic field generator 21. The movable mechanism 27 is configured to move under the magnetic force exerted by the magnetic field generator 21 between a first position P1, where it closes the release port 101, and a second position P2, where it opens the release port 101.

The movable mechanism 27 has the first position P1 where it closes the release port 101 and the second position P2 where it opens the release port 101. The movable mechanism 27 includes a magnetic movable component 28 and a retainer 23. The magnetic movable component 28 includes a sealing member 22 and a magnet 24 connected to the sealing member 22. When subjected to an external magnetic force, the magnet 24 drives the sealing member 22 to move between the first position P1 and the second position P2. The magnet 24 has a first magnetic pole close to the release port 101 and a second magnetic pole away from the release port 101. In some embodiments, the first magnetic pole is the N-pole, and the second magnetic pole is the S-pole. The retainer 23 is directly or indirectly connected to the magnet 24 or the sealing member 22, and is configured to provide a force for retaining the sealing member 22 at the first position P1. It can be understood that when the atomization device 1 is not unused, the release port 101 is in a closed initial state, and the sealing member 22 is maintained at the first position P1 for closing the release port 101.

In some embodiments, the sealing member 22 is disposed on the side of the magnet 24 close to the release port 101. In some other embodiments, the sealing member 22 encloses the magnet 24. The sealing member 22 is made of a food-grade material such as silicone or rubber. When the sealing member 22 contacts the release port 101, the sealing member 22 is compressed by the force for closing the release port 101 to become deformed, so as to form an interference fit with the release port 101, thereby enhancing the sealing effect on the release port 101 and preventing the atomization substrate from passing through the release port 101. As shown in FIG. 1, the sealing member 22 encloses the magnet 24, and the retainer 23 applies a force F0 to the sealing member 22, which keeps the sealing member 22 at the first position P1 where the release port 101 is closed.

The sealing member 22 is provided with a deformation area 220 at its end close to the release port 101. The deformation area 220 is configured to deform and fit against the wall defining the release port 101, thereby closing the release port 101. In some embodiments, the deformation area 220 protrudes outward from the surface of the sealing member 22, forming a protruding structure that substantially surrounds or inserts into the release port 101. After the sealing member 22 contacts the release port 101, the deformation area 220 is brought into contact with the release port 101 by the retainer 23 and undergoes deformation, thereby closing the release port 101.

The movable mechanism 27 includes at least one magnet 24. It can be understood that the magnet 24 has two magnetic poles of opposite polarities, typically defined as the N-pole and the S-pole. As shown in FIG. 1, in the configuration that there is one magnet 24, the two magnetic poles are arranged laterally, with the N-pole being close to the release port 101. In the configuration that the movable mechanism 27 includes two magnets 24, the heterogeneous poles of the two magnets are positioned at the same end, with one of the two magnets 24 being close to the release port 101.

The force provided by the retainer 23 may be a magnetic force for acting on the magnet 24, or alternatively, an elastic force or a thrust force for acting on the sealing member 22 or the magnet 24.

In some embodiments, the retainer 23 may be a magnetic field generator that produces magnetic force. When energized, the magnetic field generator generates a magnetic force with opposite polarity to the adjacent magnetic pole of the magnet 24. By means of the magnetic repulsive force between like poles, the magnet 24 allows the sealing member 22 to be kept at the first position P1, thereby closing the release port 101.

In some embodiments, the retainer 23 is a spring 23. As shown in FIG. 1, the spring 23 has one end fixed and the other end connected to the sealing member 22. The spring 23 applies an elastic force to keeps the sealing member 22 at the first position P1 where the release port 101 is closed.

In some embodiments, the magnetic field generator 21 is a conductive coil or an electromagnet. A conductive coil is typically formed by winding insulated copper or aluminum wire with high conductivity into a spiral shape. When electric current passes through the conductor, a magnetic field is generated. The central axis of the magnetic field is not coaxial with the magnetic axis of the magnet 24. An electromagnet includes a conductive coil and an iron core (magnetic core), with the iron core being surrounded by the conductive coil. When the conductive coil is energized to generate a magnetic field, the iron core concentrates the magnetic flux lines, thereby substantially enhancing the magnetic field strength.

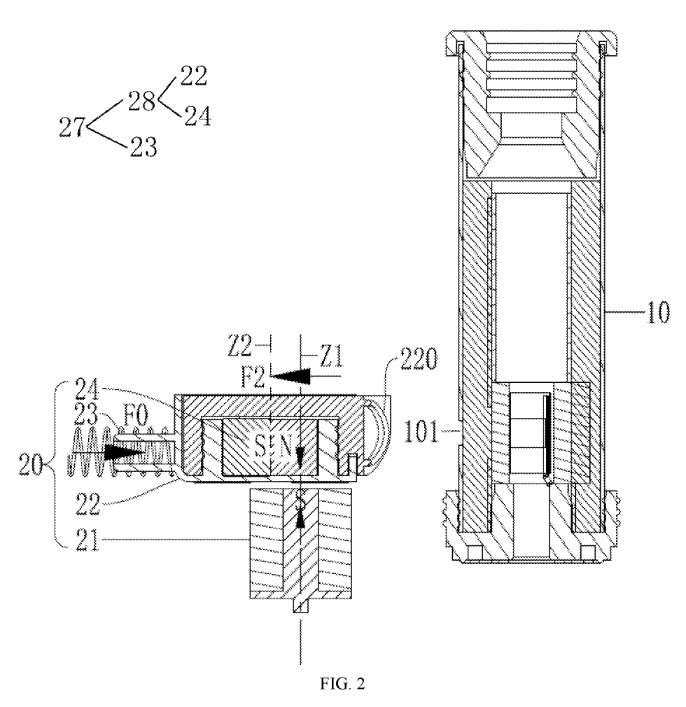

The magnetic field generator 21 includes an initial state and a use state, between which the polarity of its magnetic field is switchable. It can be understood that both the conductive coil and the electromagnet are capable of generating a magnetic field when energized. As shown in FIG. 1 or FIG. 2, the magnetic field generated by the magnetic field generator 21 has a central axis Z1, and the magnet 24 has a magnetic axis Z2, wherein Z1 and Z2 are not coaxial. It can be understandable that, when the release port 101 is in the closed state, a magnetic attractive force exists between the magnetic pole of the magnet 24 away from the release port 101 and the magnetic field generator 21.

In some embodiments, the magnetic field generator 21 has a de-energized state which corresponds to the initial state, and an energized state which corresponds to the use state. Referring to FIG. 1, the magnetic field generator 21 is an electromagnet disposed at a fixed position. In the de-energized initial state, the electromagnet does not generate a magnetic field. However, a magnetic attractive force exists between its iron core and the magnet 24. Under the action of the elastic force F0 from the spring 23, the S-pole of the magnet 24 moves toward the release port 101. As the S-pole of the magnet 24 approaches the iron core, the magnetic attractive force of the magnet 24 attracts the iron core. This magnetic attractive force further keeps the magnet 24 at the first position P1. Consequently, the release port 101 is closed by the sealing member 22.

As shown in FIG. 2, the electromagnet generates a magnetic field when energized in the use state. The polarity of the magnetic field is the same as that of the S-pole of the magnet 24, thereby generating a magnetic repulsive force; simultaneously, the polarity of the magnetic field is opposite to that of the N-pole of the magnet 24, thereby generating a magnetic attractive force. Thus, the magnet 24 is subjected to both the magnetic attractive force and the magnetic repulsive force, the resultant force of both the forces being denoted as F2. When the resultant force F2 acting on the magnet 24 exceeds the elastic force F0, the magnet 24 moves toward the magnetic field and drives the sealing member 22 to move from the first position P1 to the second position P2 away from the release port 101, thus opening the release port 101.

In some embodiments, the magnetic field generator 21 has an initial state and a use state. Referring to FIG. 1, the magnetic field generator 21 is an electromagnet; the N-pole of the magnet 24 is close to the release port 101, and the S-pole of the magnet 24 is close to the central axis of the electromagnet. In the initial state, the electromagnet generates, with its end close to the magnet 24, a magnetic field that has a polarity opposite to the S-pole of the magnet 24, and a magnetic attractive force is thereby created between them. Meanwhile, the magnetic repulsive force between the magnetic field and the N-pole of the magnet 24 is smaller than the magnetic attractive force acting on the S-pole of the magnet 24. Consequently, the net attractive force keeps the magnet 24 at the first position P1, thereby keeping the release port 101 closed by the sealing member 22. Referring to FIG. 2, in the use state, the electromagnet 24 generates, with its end close to the magnet 24, a magnetic field with the same polarity as the S-pole of the magnet 24. The magnetic field attracts the N-pole of the magnet 24. Moreover, since in the initial state the S-pole of the magnet 24 is closer to the magnetic field while the N-pole is farther away, the magnetic repulsive force acting on the S-pole of the magnet 24 is greater than the sum of the magnetic attractive force acting on its N-pole and the elastic force F0 acing on the magnet 24. The magnet 24 is subjected to both the magnetic attractive force and the magnetic repulsive force, the resultant force of both the forces being denoted as F2. When the resultant force F2 acting on the magnet 24 exceeds the elastic force F0, it drives the sealing member 22 to move close to the second position P2 away from the release port 101, thereby opening the release port 101.

The conductive coil can generate a magnetic field when energized, and the magnetic field it produces functions similarly to that generated by the electromagnet. The principles of interaction between the conductive coil and the magnet 24 will not be described herein.

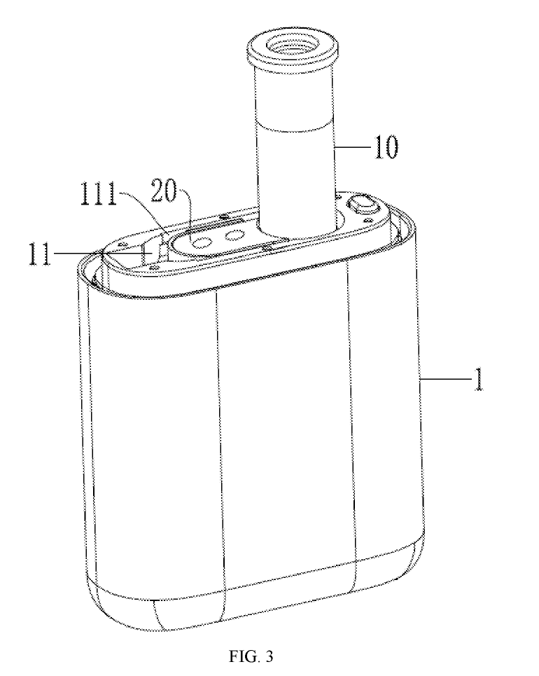

In some embodiments, as shown in FIGS. 3 to 5 , the present disclosure further provides an atomization device 1, including a fluid reservoir 30, an atomization chamber, and the magnetic fluid valve 20 as described in the foregoing embodiments. The fluid reservoir 30 is defined with the release port 101 for releasing fluid into the atomization chamber. The magnetic field generator 21 of the magnetic fluid valve 20 is switchable between the initial state and the use state, causing the magnet 24 to drive the sealing member 22 to close or open the release port 101.

The fluid reservoir 30 has a space for storing an atomization substrate and is defined with the release port 101 for releasing the atomization substrate. In some embodiments, the atomization chamber is defined by the interior space of an atomization tube 10. The atomization device 1 includes an atomization core disposed within the atomization tube 10. The atomization tube 10 and the inner wall of the hollow housing of the atomization device 1 together define the fluid reservoir 30, and the release port 101 is defined in the atomization tube 10. The movable mechanism 27 is disposed inside the fluid reservoir 30, with the sealing member 22 located on the side of the magnet 24 close to the release port 101. One end of the spring 23 is connected to the magnet 24 or the sealing member 22, and the other end of the spring 23 is connected to the inner wall of the fluid reservoir 30. The magnetic field generator 21 is disposed outside the fluid reservoir 30 and causes the magnet 24 to move by generating a magnetic field, thereby driving the sealing member 22 to move between the first position and the second position.

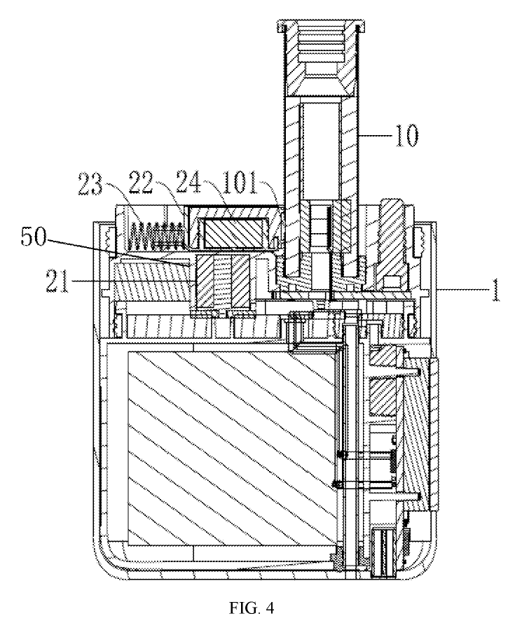

In some embodiments, a slot 11 is defined in the fluid reservoir 30, and the magnetic movable component 28 is movably mounted within the slot 11. As shown in FIG. 4, the sealing member 22 is provided with a positioning post at its end away from the release port 101 for connecting with the spring 23. One end of the spring 23 is connected to the end of the slot 11 away from the release port 101, and the other end of the spring 23 is connected to the positioning post. Under the elastic force of the spring 23, the end of the sealing member 22 close to the release port 101 extends through the slot 11 into the first position P1, engaging the atomization tube 10 to seal the release port 101.

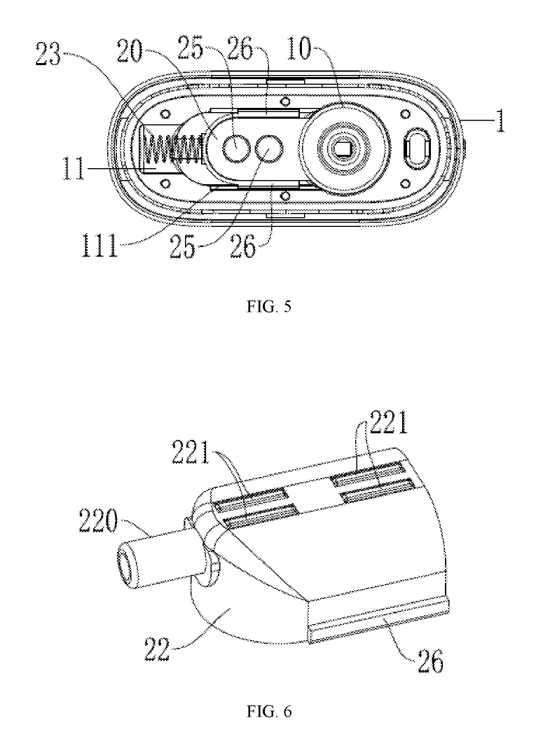

In some embodiments, the slot 11 is provided with a limiting member 111. The edge of the movable mechanism 27 is provided with a protrusion 26 that is configured to cooperate with the limiting member 111 to restrict the range of movement of the movable mechanism 27. The limiting member 111 includes an end close to the release port 101 and the other end away from it. The two ends respectively define the first position P1 where the movable mechanism 27 closes the release port 101, and the second position P2 where the movable mechanism 27 opens the release port 101. In some embodiments, as shown in FIG. 5, the slot 11 extends along a direction radially along the atomization tube 10. Recessed limiting members 111 are respectively arranged on two sides of the slot 11, and protrusions 26 are respectively arranged on two side edges of the movable mechanism 27 and are received within the limiting members 111.

During movement, the movable mechanism 27 comes into contact with the inner wall of the housing, generating a frictional force. As shown in FIGS. 1 and 6 , the sealing member 22 encloses the magnet 24, and the surface of the sealing member 22 is provided with ribs 221 that contact the fluid reservoir 30, thereby reducing the frictional force between the movable mechanism 27 and the inner wall of the fluid reservoir 30.

In some embodiments, the interior of the fluid reservoir 30 is partitioned into a fluid accommodation cavity 31 for storing the atomization substrate and an installation cavity 32 by way of a partition 40. As shown in FIG. 5, the partition 40 is mounted on the slot 11. The partition 40 and the slot 11 together define the installation cavity 32. The installation cavity 32 is defined with an opening at a side close to the release port 101. The movable mechanism 27 is disposed within the installation cavity 32. The sealing member 22 is kept at the first position P1 under the action of the spring 23. A portion of the sealing member 22 passes through the opening 320 to abut against the atomization tube 10, thereby sealing the release port 101.

In some embodiments, the partition 40 is defined with a viewing hole 25, and at least a portion of the fluid reservoir 30 is transparent, such that the position of the movable mechanism 27 is visible through the viewing hole 25. In some embodiments, the partition may be defined with at least two viewing holes 25 located between the first position P1 and the second position P2, through each of which a different position of the movable mechanism 27 is visible.

In some embodiments, the atomization device 1 further includes a bracket 50 disposed outside the fluid reservoir 30. The magnetic field generator 21 is fixedly mounted on the bracket 50. In some embodiments, the atomization device 1 further includes a power source electrically connected to the magnetic field generator 21.

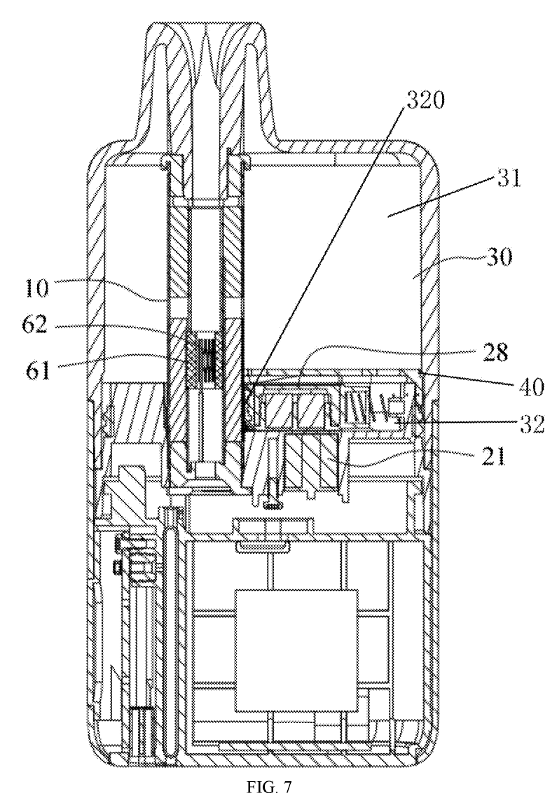

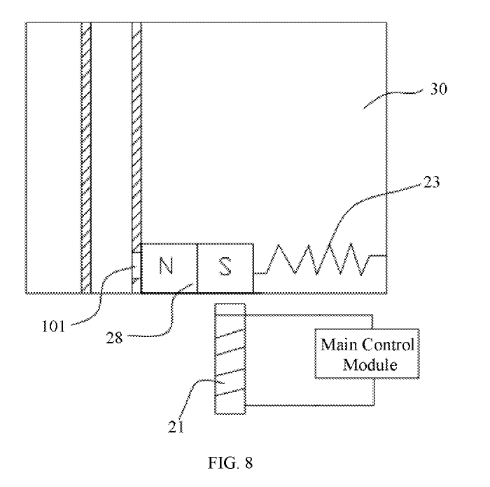

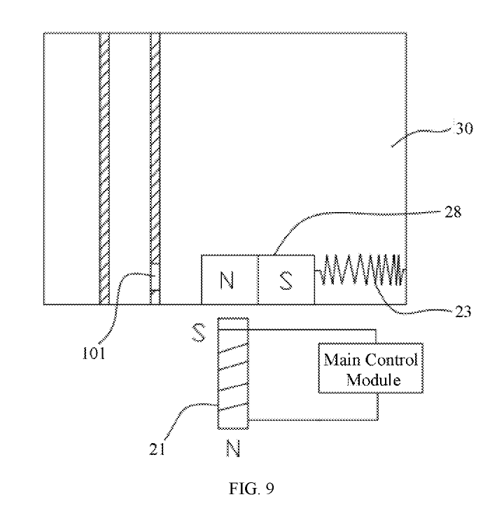

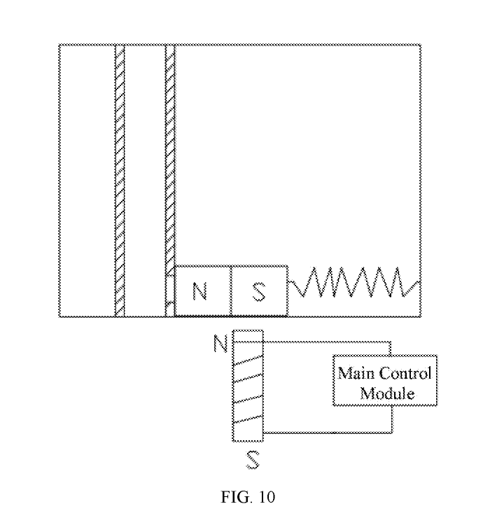

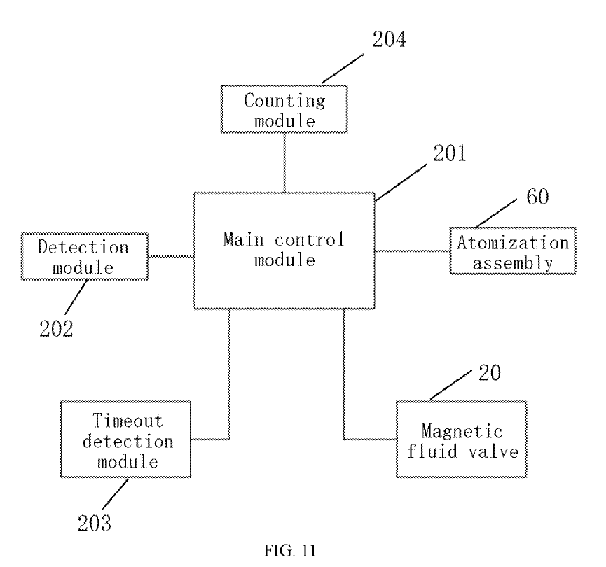

In some embodiments, with reference to FIGS. 7 to 10 , the atomization device 1 includes a fluid reservoir 30 configured to store e-liquid. A main body is disposed below the fluid reservoir 30. The main body is provided with a battery and a circuit board or a chip. An upper portion of the main body is provided with a magnetic field generator 21. The main body defines an air intake passage, inside which there is an airflow sensing member, such as a microphone-type sensor or an airflow sensor. The air intake passage has a lower portion communicated with the external environment. An upper portion of the fluid reservoir 30 is provided with a mouthpiece, and a lower portion of the fluid reservoir 30 is defined with an air inlet. An atomization tube 10 is provided between the mouthpiece and the air inlet. A release port 101, also referred to as an e-liquid inlet, is defined in a side wall of the atomization tube 10. An atomization assembly 60 is provided within the atomization tube 10. The atomization assembly 60 includes an e-liquid guiding element 61 and a heating element 62. The e-liquid guiding element 61 may be a e-liquid guiding cotton, porous ceramic, or the like. The heating element 62 may be a heating wire, a heating plate, a heating mesh, a heating film, or the like. The e-liquid guiding element 61 is configured to transport e-liquid, and the heating element 62 is configured to heat the e-liquid to generate aerosol. The heating element 61 includes two end that are respectively connected to the circuit board or the chip via conductive wires. The battery, the magnetic field generator 21, and the airflow sensor are each connected to the circuit board or the chip. During inhalation through the mouthpiece, air in the air intake passage flows, and the airflow sensor detects the change in air pressure and sends an electrical signal to the circuit board or the chip. The circuit board or the chip then supplies electrical energy from the battery to the heating element 62. After being energized, the heating element 62 generates heat, which vaporizes the e-liquid absorbed on the inner side of the e-liquid guiding element 61 into aerosol. The aerosol flows upward along the atomization tube 10. Meanwhile, external air enters through the air intake passage, passes through the air inlet, and flows upward along the atomization tube 10. The external air mixes with the aerosol and continues to flow upward until it exits through the mouthpiece. When inhalation stops, the airflow sensor stops sending the electrical signal to the circuit board or the chip, which then controls the battery to stop supplying power to the heating element 62.

In the embodiments, the atomization assembly 60 and the fluid reservoir 30 are communicated through the release port 101 . The magnetic movable component 28 is disposed inside the fluid reservoir 30. The spring 23 is disposed between the magnetic movable component 28 and an inner wall of the fluid reservoir 30. The magnetic movable component 28 includes two magnetic poles of opposite polarities disposed opposite each other, with one magnetic pole close to the release port 101 and the other magnetic pole close to the spring 23. The magnetic field generator 21 is disposed external to the fluid reservoir 30.

In some embodiments, the magnet 24 includes the N-pole and the S-pole. The sealing member 22 is made of a silicone material. The magnetic movable component 28 is slidable along the bottom of the fluid reservoir 30. In some embodiments, the left side of the magnet 24, i.e., the side closer to the release port 101, is the N-pole; and the right side of the magnet 24, i.e., the side away from the release port 101, is the S-pole. After the magnetic field generator 21 is energized, its upper end becomes the S-pole and its lower end becomes the N-pole. Once the magnetic field generator 21 is de-energized, its magnetism disappears. In the initial state, the spring 23 is in a compressed state, but the compressive force is relatively small. This force enables the magnetic movable component 28 to press against the release port 101, preventing the e-liquid from flowing out through the release port 101, while also preventing the magnetic movable component 28 from separating from the release port 101. The magnetic movable component 28 is positioned on the left side of the fluid reservoir 30, with its left side blocking the release port 101. At this point, the spring 23 cannot pull the magnetic movable component 28 away, and the e-liquid within the fluid reservoir 30 cannot enter the e-liquid guiding element 61 through the release port 101. This achieves sealing of the e-liquid, preventing it from leaking out. Thus, it ensures the quality of the e-liquid by avoiding long-term exposure to air, which could lead to volatilization or oxidation of the e-liquid.

The movement of the magnetic field generator 21 may be categorized into three scenarios, which are described below.

In the first scenario, after the magnetic field generator 21 is energized with a current in a first direction, the magnetic pole of the magnetic movable component 28 close to the release port 101 is attracted by the magnetic field generator 21, while the magnetic pole close to the spring 23 is subjected to an upward repulsive force. As a result, the magnetic movable component 28 moves horizontally away from the release port 101 and compresses the spring 23, thereby opening the release port 101. This allows the e-liquid within the fluid reservoir 30 to enter the e-liquid guiding element 61 through the release port 101. In some embodiments, the upper end of the magnetic field generator 21 is the S-pole. Accordingly, the N-pole on the left side of the magnetic movable component 28 is attracted by the magnetic field generator 21, while the S-pole on the right side of the magnetic movable component 28 is subjected to an upward repulsive force. As a result, the magnetic movable component 28 moves to the right, opening the release port 101, with the spring 23 being in a compressed state. When the N-pole on the left side of the magnetic movable component 28 moves directly above the magnetic field generator 21, the magnetic movable component 28 stops moving. At this point, the attractive force between the N-pole on the left side of the magnetic movable component 28 and the S-pole at the upper end of the magnetic field generator 21 reaches its maximum.

In the second scenario, after the magnetic field generator 21 is energized with a current in a second direction, the magnetic pole of the magnetic movable component 28 close to the release port 101 is subjected to an upward repulsive force, while the magnetic pole of the magnetic movable component 28 close to the spring 23 is attracted by the magnetic field generator 21. As a result, the magnetic movable component 28 moves horizontally toward the release port 101, closing the release port 101. This corresponds to the forced-closure of the release port 101. In some embodiments, the upper end of the magnetic field generator 21 is the N-pole, and its lower end is the S-pole. Accordingly, the N-pole on the left side of the magnetic movable component 28 is repelled by the N-pole at the upper end of the magnetic field generator 21, resulting in an upward repulsive force acting on the N-pole of the magnetic movable component 28. Simultaneously, the S-pole on the right side of the magnetic movable component 28 is attracted by the N-pole at the upper end of the magnetic field generator 21. Consequently, the magnetic movable component 28 moves to the left, overlaying a leftward propelling force from the compressed spring 23. These two forces act together on the magnetic movable component 28, driving the movable component 28 leftward. The upward repulsive force acting on the N-pole of the magnetic movable component 28 reduces frictional resistance during movement, allowing the magnetic movable component 28 to smoothly travel to the release port 101 and thereby blocking it.

In a third scenario, when the magnetic field generator 21 is de-energized, the magnetic movable component 28 presses against the release port 101, thereby closing it, without requiring energizing the magnetic field generator 21. The magnetic movable component 28 is pushed by the spring 23 to move toward the release port 101 and ultimately blocking the release port 101. As described in the first scenario, the upper end of the magnetic field generator 21 is the S-pole, the N-pole on the left side of the magnetic movable component 28 is attracted to the magnetic field generator 21, while the S-pole on the right side of the magnetic movable component 28 is subjected to an upward repulsive force. Consequently, the magnetic movable component 28 moves rightward, opening the release port 101, with the spring 23 being in a compressed state. When the N-pole on the left side of the magnetic movable component 28 moves directly above the magnetic field generator 21, the movement stops, and the attractive force between the N-pole on the left side of the magnetic movable component 28 and the S-pole at the upper end of the magnetic field generator 21 reaches its maximum. At this point, the magnetic field generator 21 is de-energized, its magnetism disappears. Driven by the spring 23, the magnetic movable component 28 moves toward the release port 101 so as to block it. In this scenario, the magnetic field generator 21 does not need to be energized. By relying on the compression of the spring 23 and the subsequent release of its stored energy, the elastic potential energy is converted into kinetic energy, which pushes the magnetic movable component 28 toward the release port 101. The magnetic movable component 28 then remains at the release port 101 to achieve oil sealing. Since no electrical power is required, energy consumption can be saved. Since the release port 101 needs to be sealed under normal conditions, it is impractical to continuously energize the magnetic movable component 28 to maintain the sealed state. This also avoids the overheating of the magnetic field generator 21 caused by prolonged energization. The orientation of the S-pole and N-pole of the magnetic movable component 28 can be reversed, and the polarity of the magnetic field generator 21 can also be switched by changing the direction of the applied electric current. Detailed descriptions thereof are not detailed herein, as the operating principle remains the same as described above.

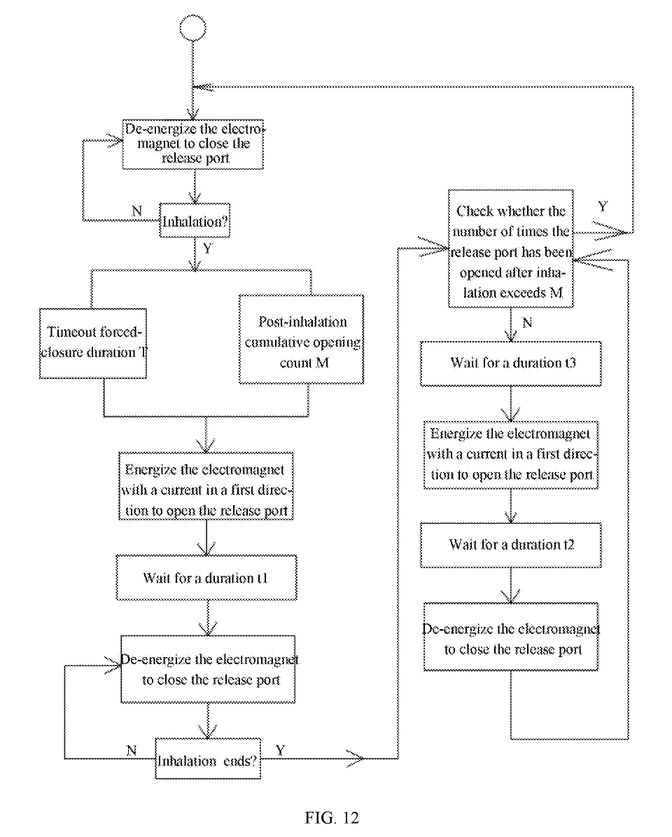

In some embodiments, referring to FIG. 11, the present disclosure further provides a control system 200 for an atomization device. The system 200 includes a main control module 201, a detection module 202, a timeout detection module 203, and a counting module 204. The specific functions of these modules are as follows.

The main control module 201 is also referred to as a main control chip or a processing center. The main control module 201 is preset with a timeout forced-closure duration T and a post-inhalation cumulative opening count M for the release port 101. The timeout forced-closure duration T represents a time period from an initial opening of the release port 101 until the release port 101 is required to be forcibly closed. The post-inhalation cumulative opening count M represents the number of additional cumulative openings required for the release port 101 after inhalation ends.

The main control module 201 is connected to the atomization assembly 60 of atomization device 1. The main control module 201 is configured to send an electrical signal to the atomization assembly 60. After receiving the electrical signal from the main control module 201, the atomization assembly 60 starts atomization. During inhalation, the atomization assembly 60 is energized to heat the e-liquid. When inhalation stops, the atomization assembly 60 is de-energized and heating ceases, awaiting the next inhalation cycle to resume operation.

The main control module 201 is further connected to the magnetic fluid valve 20 of the atomization device 1. The main control module 201 controls the magnetic fluid valve 20 to open the release port 101, allowing e-liquid to enter the atomization assembly 60 through the release port 101. For instance, in the first scenario as described above, when the magnetic actuator 21 is energized with the current in the first direction, the release port 101 is opened. This corresponds to the normal opening of the release port 101 during initial inhalation, facilitating the passage of e-liquid into the atomization assembly 60 through the release port 101. The opening duration of the release port 101 is relatively short (e.g., approximately 100 milliseconds). The amount of e-liquid intake during this opening is sufficient to supply a single inhalation. Maintaining the release port 101 open for an extended period would require continuous energization of the magnetic field generator 21. This not only leads to power wastage but also causes heat generation. Therefore, a brief opening of the release port 101 is sufficient for oil supply and energy saving.

The main control module 201 is further configured to control the magnetic fluid valve 20 to close the release port 101, preventing e-liquid from flowing out through the release port 101. For example, in the third scenario as described above, when the magnetic field generator 21 is not energized, the magnetic movable component 28 is pushed by the spring 23 to press against and close the release port 101. This non-energized approach effectively saves electrical energy and achieves the sealing of the release port 101. In this scenario, there is no need to apply a current in the second direction to drive the magnetic movable component 28 to block the release port 101, as the magnetic movable component 28 is compressed by the spring 23. Releasing the potential energy stored in the spring 23 allows it to push the magnetic movable component 28 to seal the release port 101, achieving energy conversion and efficient utilization. This scenario may also be implemented by energizing the magnetic field generator 21. For instance, applying a current in the second direction to the magnetic field generator 21 causes it to drive the magnetic movable component 28 to close the release port 101.

The main control module 201 is further configured to control the magnetic fluid valve 20 to forcibly close the release port 101. For example, as described in the second scenario above, after the magnetic field generator 21 is energized with a current in the second direction, the magnetic movable component 28 moves horizontally toward the release port 101, thereby closing the release port 101. By setting the timeout forced-closure duration T, it is possible to prevent the magnetic movable component 28 from stopping at certain point along its travel path. For example, the magnetic movable component 28 moves toward the release port 101 via the push of the spring 23 but becomes stuck at a certain point along its travel path. At this moment, the release port 101 is not yet closed by the magnetic movable component 28 and remains open. However, the main control module 201 is unaware that the magnetic movable component 28 has stopped moving. When the time measured from the initial opening of the release port 101 reaches the timeout forced-closure duration T, the magnetic movable component 28 must return to its initial position and close the release port 101. This requires applying a force to the magnetic movable component 28, which is provided by the magnetic field generator 21. By applying a current in the second direction to the magnetic field generator 21, it drives the magnetic movable component 28 to move horizontally toward the release port 101, thereby forcibly closing the release port 101. This process is also referred to as a forced reset of the magnetic movable component 28, which effectively prevents e-liquid leakage caused by the release port 101 being left open.

The detection module 202 is connected to the main control module 201. The detection module 202 is configured to detect whether there is an inhalation action and send an electrical signal to the main control module 201 in response to detecting an inhalation action. The detection module 202 may be an airflow sensor, a microphone element, or the like. When inhalation begins, a change in air pressure triggers the detection module 202 to send an electrical signal to the main control module 201. When inhalation stops, the detection module 202 is no longer triggered and returns to a standby state, and it does not send an electrical signal to the main control module 201. When the next inhalation begins, the detection module 202 is triggered again to send an electrical signal to the main control module 201.

The timeout detection module 203 is connected to the main control module 201. When the main control module 201 controls the magnetic fluid valve 20 to open the release port 101, the timeout detection module 203 starts timing. When the timing duration reaches the preset timeout forced-closure duration T, the timeout detection module 203 sends a signal to the main control module 201, and the main control module 201 controls the magnetic fluid valve 20 to forcibly close the release port 101. The timeout detection module 203 is configured to detect whether the timing duration reaches the timeout forced-closure duration T, thereby preventing abnormal situations from occurring. The start point of the timing may be the beginning of an inhalation, this is because when an inhalation occurs, the detection module 202 sends an electrical signal to the main control module 201, and in response to receiving the electrical signal, the main control module 201 controls the release port 101 to be opened and controls the atomization assembly 60 to start atomization. These two processes occur almost simultaneously. When the timing duration from the initial opening of the release port 101 reaches the timeout forced-closure duration T, it indicates that one operating cycle has been completed, and the system must return to the initial state, i.e., the magnetic movable component 28 is reset to its original position to close the release port 101. For instance, if the timeout forced-closure duration T is set to 5 minutes, this means that after 5 minutes of inhalation, regardless of the state of the release port 101, a forced closure is triggered. On one hand, this prevents the magnetic movable component 28 from becoming accidentally stuck during sliding; on the other hand, the reverse magnetic force generated by the magnetic field generator 21 ensures precise alignment between the magnetic movable component 28 and the release port 101. In some embodiments, the timeout detection module 203 is a timer.

The counting module 204 is connected to the main control module 201. After the inhalation ends, the counting module 204 begins to obtain the remaining number of openings required for the release port 101 and sends the remaining number of openings to the main control module 201. Based on the remaining number of openings, the main control module 201 determines whether to open or close the release port 101. For example, if the post-inhalation cumulative opening count M is set to 3, after the inhalation ends, the counting module 204 starts to obtain the remaining number of openings required for the release port 101. If the remaining number of openings is 2, the release port 101 is required to be opened twice more. The release port 101 is opened by energizing the magnetic field generator 21. Each time the release port 101 is opened, e-liquid from the fluid reservoir 30 passes through the release port 101 into the atomization assembly 60, replenishing the e-liquid supply and priming the e-liquid guiding cotton. The magnetic field generator 21 is then de-energized, such that the magnetic movable component 28 returns to its initial position driven by the spring 23, closing the release port 101, preparing for the next inhalation and preventing dry burning of the heating element 62. With each opening of the release port 101, the number of times that the release port has already been opened after inhalation end is increased by one, which is equivalent to decreasing the remaining number of openings for the release port 101 after inhalation ends by one, until the remaining number of openings for the release port 101 after inhalation ends reaches zero.

The power module 205 is connected to the main control module 201. In some embodiments, the power module 205 is a battery. The power module 205 is configured to supply power to the main control module 201. The main control module 201 may supply power to the detection module 202, the timeout detection module 203, and the counting module 204. Alternatively, the power module 205 may supply power to the detection module 202, the timeout detection module 203, and the counting module 204.

After inhalation ends, the counting module 204 starts to obtain the remaining number of openings for the release port 101. If the remaining number of openings for the release port 101 after inhalation ends equals zero, the magnetic field generator 21 is de-energized, and the main control module 201 initiates a shutdown procedure. If the remaining number of openings for the release port 101 after inhalation ends is greater than zero, it is necessary to wait for a duration t3 (e.g., approximately 3 seconds), and then the main control module 201 controls the magnetic fluid valve 20 to open the release port 101. The release port 101 stays open for a duration t2 (e.g., approximately 100 milliseconds) before being closed. The number of times that the release port has already been opened after inhalation ends is increased by one. The counting module 204 continues to obtain the remaining number of openings for the release port 101 after inhalation ends. The above process is repeated until the remaining number of openings equals zero. Each time the release port 101 is opened, e-liquid from the fluid reservoir 30 flows through the release port 101 into the atomization assembly 60. This replenishes the e-liquid in the atomization assembly 60, preparing it for the next inhalation.

The magnetic field generator 21 is an electromagnet. During inhalation, by energizing the magnetic field generator 21 with a current in the first direction, the main control module 201 controls the magnetic fluid valve 20 to open the release port 101, allowing e-liquid to flow through the release port 101 into the atomization assembly 60, replenishing the e-liquid supply. By de-energizing the magnetic field generator 21, the main control module 201 controls the magnetic fluid valve 20 to close the release port 101. This prevents excessive e-liquid from entering the atomization assembly 60 and also enables efficient use of electrical energy. There is no need to apply a current in a second direction to the magnetic field generator 21 to drive the magnetic movable component 28 to block the release port 101. Instead, the potential energy of the spring 23 is rationally utilized. The potential energy of the spring 23 is converted into the kinetic energy of the magnetic movable component 28, moving the magnetic movable component 28 back to its initial position. By energizing the magnetic field generator 21 with a current in the second direction, where the second direction is opposite to the first direction, the main control module 201 controls the magnetic fluid valve 20 to forcibly close the release port 101. This constitutes a forced closure of the release port 101 and serves as a system protection measure. After the release port 101 is forcibly closed, if another inhalation is required, the system returns to its initial state. During inhalation, the release port 101 is opened, allowing e-liquid to enter the e-liquid guiding cotton through the release port 101, thereby preventing dry firing of the heating element 62.

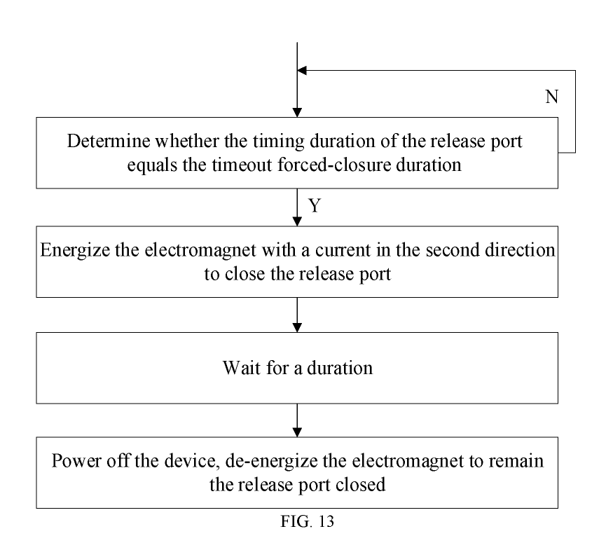

Referring to FIGS. 12 and 13 , in some embodiments, the present disclosure further provides a control method for an atomization device. The atomization device is the atomization device described in the foregoing embodiments. The control method includes:

S1. Upon power-on and initialization of the atomization device, the magnetic movable component 28 blocks the release port 101, thereby closing it. The fluid reservoir 30 contains e-liquid, and the e-liquid guiding cotton is pre-saturated with a preset amount of e-liquid.

S2. The detection module 202 detects whether an inhalation action occurs. If an inhalation action is detected, it sends an electrical signal to the main control module 201; if no inhalation action is detected, it does not send electrical signal to the main control module 201.

After receiving the electrical signal, the main control module 201 controls the magnetic fluid valve 20 to open the release port 101. After the magnetic field generator 21 is energized with a current in the first direction, the magnetic pole of the magnetic movable component 28 close to the release port 101 is attracted by the magnetic field generator 21, while the magnetic pole of the magnetic movable component 28 close to the spring 23 is subjected to an upward repulsive force. Consequently, the magnetic movable component 28 moves horizontally away from the release port 101 to compress the spring 23, thereby opening the release port 101. This allows e-liquid to enter the atomization assembly 60 through the release port 101. After the release port 101 remains open for a duration t1 (e.g., approximately 100 milliseconds), it is closed. In this case, the magnetic field generator 21 does not require energization. Driven by the spring 23, the magnetic movable component 28 moves toward the release port 101, ultimately closing it. With each instance of inhalation, the release port 101 is opened once. The opening of the release port 101 is achieved by the horizontal movement of the magnetic movable component 28 away from the release port 101, thereby compressing the spring 23. After the release port 101 remains open for the duration t1, the magnetic movable component 28 moves toward the release port 101 driven by the elastic force of the spring 23, thereby closing the release port 101. Each opening of the release port 101 is for replenishing e-liquid to the atomization assembly once, after that the release port 101 is closed. The closing operation simply requires de-energizing the electromagnet.

After receiving the electrical signal, the main control module 201 also controls the atomization assembly 60 to begin atomization. The main control module 201 controls the battery to supply power to the heating element 62. After energized, the heating element 62 heat and vaporize the e-liquid within the e-liquid guiding element 61 into aerosol.

S3. The detection module 202 continuously monitors for inhalation actions. If an inhalation action is detected, the detection module 202 sends an electrical signal to the main control module 201. The main control module 201 controls the battery to supply power to the heating element 62, causing the atomization assembly 60 to perform a continuous atomization operation. If no inhalation action is detected, the main control module 201 controls the battery to cut off power to the heating element 62, thereby stopping the atomization.

S4. When no inhalation action is detected for a continuous duration t3, wherein t3 may be 3 seconds, 5 seconds, 7 seconds, etc., the main control module 201 determines that inhalation has stopped and proceeds to step S5.

S5. The main control module 201 checks the remaining number of openings for the release port 101 after inhalation. If the remaining number of openings equals zero, the main control module 201 controls the atomization device to power off. If the remaining number of openings is greater than zero, step S6 is performed.

S6. The main control module 201 controls the magnetic fluid valve 20 to open the release port 101. After the release port 101 remains open for a duration t2 (e.g., approximately 100 milliseconds), it is closed. Subsequently, the main control module 201 waits for the fixed duration t3 and then continues to check the remaining number of openings for the release port 101 after inhalation, repeating step S5. The main control module 201 waiting for the duration t3 serves to further determine whether the user intends to continue inhalation.

According to the control method, the release port 101 is opened when inhalation is required, and is closed without requiring electrical power when inhalation is not required, thereby effectively saving energy. After inhalation ends, subsequent openings for the release port 101 allow e-liquid to fully saturate the e-liquid guiding cotton, preparing it for the next inhalation and effectively preventing dry-burning of the heating element 62. When the atomization device 1 is not in use, the release port 101 remains closed by default, effectively preventing e-liquid leakage and addressing the issue of e-liquid leakage during transportation.

In step S2, after receiving the electrical signal, the main control module 201 controls the timeout detection module 203 to begin timing. When the timing duration reaches the timeout forced-closure duration T, the timeout detection module 203 sends a signal to the main control module 201, and the main control module 201 controls the magnetic fluid valve 20 to perform a forced-closure of the release port 101. This is achieved by energizing the magnetic field generator 21 with a current in the second direction, causing the magnetic movable component 28 to close the release port 101. After a fixed duration, for example, 100 milliseconds, the electromagnet is de-energized. The magnetic movable component 28 remains in position, keeping the release port 101 closed, and the device is powered off. When the timing duration has not yet reached the timeout forced-closure duration T, the forced-closure of the release port 101 is not performed. This, on the one hand, prevents the magnetic movable component 28 from becoming accidentally stuck during its sliding movement, and on the other hand, allows the reverse magnetic force generated by the magnetic field generator 21 to accurately align the magnetic movable component 28 with the release port 101, allowing for device initialization and preventing dry firing of the heating element 62.

The magnetic field generator 21 is an electromagnet. When the magnetic field generator 21 is energized with a current in the first direction, the magnetic movable component 28 moves away from the release port 101, thereby opening the release port 101. When the magnetic field generator 21 is energized with a current in the second direction, the magnetic movable component 28 moves toward the release port 101, thereby closing the release port 101. This allows the magnetic fluid valve 20 to forcibly close the release port 101. The second direction is opposite to the first direction. When a current in the second direction is applied to the magnetic field generator 21, it enhances the thrust exerted by the magnetic field generator 21 on the magnetic movable component 28. Along with the thrust from the spring 23, these two forces jointly act on the magnetic movable component 28, returning it to its initial position. This prevents the magnetic movable component 28 from stopping at any point along its travel path, thereby avoiding leakage of e-liquid through the release port 101. As a result, the release port 101 is reliably opened during use and effectively closed when not in use.

In step S2, when the magnetic field generator 21 is energized with a current in the first direction, the magnetic movable component 28 moves away from the release port 101 to open the release port 101. After the release port 101 remains open for the duration t1, the magnetic field generator 21 is de-energized. Subsequently, driven by the spring 23, the magnetic movable component 28 moves toward the release port 101 to close the release port 101. In this case, the closure of the release port 101 is not achieved through a forced closure, but rather by converting the potential energy stored in the spring 23 into the kinetic energy of the magnetic moving part 28. This avoids the need to supply a current in the second direction to the magnetic field generator 21 again, thereby saving electrical energy. It also enables effective energy conversion and prevents the magnetic field generator 21 from heating up due to prolonged energization.

In step S6, when the magnetic field generator 21 is energized with a current in the first direction, the magnetic movable component 28 moves away from the release port 101 to open the release port 101. After the release port 101 remains open for the duration t2 to ensure that e-liquid passes through it and saturates the e-liquid guiding cotton, the magnetic field generator 21 is de-energized. Subsequently, driven by the spring 23, the magnetic movable component 28 moves toward the release port 101 to close the release port 101, thereby completing one e-liquid replenishment process. This also provides sufficient e-liquid for the next atomization operation of the atomization assembly, preventing dry burning of the heating element 62. To allow the e-liquid guiding cotton to fully absorb the e-liquid, the magnetic field generator 21 may be energized again with a current in the first direction, causing the magnetic movable component 28 to move away from the release port 101 and open the release port 101. After the release port 101 remains open for the duration t2, another e-liquid replenishment process is completed. The release port 101 is then closed by relying on the potential energy stored in the spring 23.

In step S5, after inhalation ends, the main control module 201 obtains the remaining number of openings for the release port 101. In some embodiments, the main control module 201 is preset with the post-inhalation cumulative opening count M, wherein the post-inhalation cumulative opening count M represents the number of additional cumulative openings required for the release port 101 after inhalation ends. The counting module 204 is configured to obtain the remaining number of openings for the release port 101 after inhalation end, and then send the remaining number of openings to the main control module 201. If the remaining number of openings equals to zero, it indicates that the e-liquid guiding cotton already contains sufficient e-liquid and no further opening of the release port 101 is needed to replenish e-liquid. In this case, the magnetic field generator 21 is de-energized, and the main control module 201 controls the atomization device to power off. If the remaining number of openings is greater than zero, the main control module 201 waits for the duration t3 before proceeding to perform step S6.

The above are only some embodiments of the present disclosure, and neither the words nor the drawings can limit the protection scope of the present disclosure. Any equivalent structural transformation made by using the contents of the specification and the drawings of the present disclosure under the overall concept of the present disclosure, or directly/indirectly applied in other related technical fields are included in the protection scope of the present disclosure.

What is claimed is:

1. An atomization device, comprising a fluid reservoir and a magnetic fluid valve, the fluid reservoir being defined with a release port for releasing fluid to outside, the magnetic fluid valve being configured to close or open the release port, and the magnetic fluid valve comprising:
a magnetic field generator and a movable mechanism configured to move relative to the magnetic field generator, the movable mechanism comprising a magnetic movable component and a retainer, and the magnetic movable component comprising:
a sealing member, configured to move between a first position for closing the release port and a second position for opening the release port; and
a magnet, configured to drive the sealing member to move between the first position and the second position under the action of an external magnetic force, the magnet having a first magnetic pole close to the release port and a second magnetic pole away from the release port, wherein the first magnetic pole and the second magnetic pole have opposite polarities;
wherein the retainer is configured to provide a force for retaining the sealing member at the first position; and
the magnetic field generator is configured to generate a magnetic field acting on the magnet, and the magnetic field generator comprises an initial state and a use state; wherein,
in the initial state, the magnetic field generator is capable of, when energized, generating a magnetic field that attracts the second magnetic pole of the magnet, to drive the movable mechanism to move close to the first position or maintain the movable mechanism at the first position; or the magnetic field generator is not energized, and the retainer is configured to provide the force to keep the magnetic field generator at the first position; and
in the use state, the magnetic field generator is capable of, when energized, generating a magnetic field that attracts the first magnetic pole of the magnet, to drive the movable mechanism to move from the first position to the second position.

2. The atomization device of claim 1, wherein
the sealing member is made of a deformable material, and at least a portion of the sealing member is fixed to a side of the magnet close to the release port;
or
the retainer is a spring, and the magnetic field generator is a conductive coil or an electromagnet.

3. The atomization device of claim 1, wherein the movable mechanism is disposed inside the fluid reservoir, the sealing member is located at a side of the magnet close to the release port, the retainer is disposed between an inner wall of the fluid reservoir and the magnet or between an inner wall of the fluid reservoir and the sealing member, and the magnetic field generator is disposed outside the fluid reservoir.

4. The atomization device of claim 1, wherein the sealing member encloses the magnet, and a surface of the sealing member in contact with the fluid reservoir is provided with a plurality of spaced-apart ribs.

5. The atomization device of claim 1, wherein
an interior of the fluid reservoir is divided into a fluid accommodation cavity and an installation cavity by a partition, the installation cavity is defined with an opening at a side close to the release port, the movable mechanism is disposed in the installation cavity, and the sealing member, when in the first position, at least partially extends through the opening and closes the release port; and
the atomization device further comprises a bracket disposed outside the fluid reservoir, and the magnetic field generator is fixed on the bracket.

6. The atomization device of claim 1, wherein the atomization device further comprises a battery and a circuit board connected to the battery; the first magnetic pole is downward, the second magnetic pole is downward, and the magnetic field generator is fixed below the fluid reservoir, the magnetic field generator is an electromagnet connected to the circuit board;
when the electromagnet is energized with a current in a first direction, a first induced magnetic pole is generated at an upper end of the electromagnet, to drive the magnetic movable component to move from the first position to the second position, wherein a polarity of the first induced magnetic pole is opposite to a polarity of the first magnetic pole and is the same as a polarity of the second magnetic pole; and
when the electromagnet is energized with a current in a second direction, a second induced magnetic pole is generated at the upper end of the magnetic field generator, to drive the magnetic movable component to move from the second position to the first position, wherein a polarity of the second induced magnetic pole is opposite to the polarity of the second magnetic pole and is the same as the polarity of the first magnetic pole;
wherein the second direction is opposite to the first direction.

7. The atomization device of claim 1, wherein the magnetic field generator is an electromagnet, the first magnetic pole and the second magnetic pole are integrally arranged or separately arranged, and the electromagnet is located directly below the magnetic movable component; and
when the sealing member is in the first position, a magnetic axis of the magnet is located between a central axis of the electromagnet and the release port; and when the sealing member is in the second position, the central axis of the electromagnet is located between the magnetic axis of the magnet and the release port;
wherein the magnetic axis of the magnet is located at a center between the first magnetic pole and the second magnetic pole, and the central axis of the electromagnet is located at a center of the magnetic field generated by the electromagnet.

8. A control system for an atomization device, the atomization device being the atomization device of claim 1, the atomization device further comprising an atomization assembly communicated with the fluid reservoir through the release port, and the control system comprising:
a main control module, the main control module being preset with a timeout forced-closure duration and a post-inhalation cumulative opening count for the release port, wherein the timeout forced-closure duration refers to a time period from an initial opening of the release port until the release port is required to be forcibly closed, and the post-inhalation cumulative opening count refers to the number of additional openings required for the release port after that inhalation ends; the main control module being electrically connected to the atomization assembly, and configured to control the atomization assembly to perform atomization; and the main control module being further electrically connected to the magnetic fluid valve, and further configured to control the magnetic fluid valve to open or close the release port, and to control the magnetic fluid valve to forcibly close the release port;
a detection module connected to the main control module, the detection module being configured to send an electrical signal to the main control module in response to detecting an inhalation action;
a timeout detection module connected to the main control module, the timeout detection module being configured to start timing when the main control module controls the magnetic fluid valve to open the release port, and the timeout detection module being further configured to send a signal to the main control module when a timing duration reaches the timeout forced-closure duration, to allow the main control module to control the magnetic fluid valve to forcibly close the release port;
a counting module connected to the main control module, the counting module being configured to, after inhalation ends, obtain a remaining number of openings required for the release port and sends the remaining number of openings to the main control module, to allow the main control module to control the magnetic fluid valve to open or close the release port based on the remaining number of openings; wherein the remaining number of openings equals the post-inhalation cumulative opening count minus the number of times that the release port has already been opened after inhalation ends; and
a power supply module connected to the main control module.

9. The control system of claim 8, wherein
in response to determining that the remaining number of openings equals to zero, the magnetic field generator is de-energized, and the main control module controls the atomization device to power off;
in response to determining that the remaining number of openings is greater than zero, after waiting for a first duration, the main control module controls the magnetic fluid valve to open the release port for a second duration, and then controls the magnetic fluid valve to close the release port; the number of times that the release port has already been opened after that inhalation ends is incremented by one; and the counting module continues to obtain the remaining number of openings until the remaining number of openings equals to zero.

10. The control system of claim 8, wherein the magnetic field generator is an electromagnet, and during inhalation,
in a case that the electromagnet is energized with a current in a first direction, the main control module controls the magnetic fluid valve to open the release port;
in a case that the electromagnet is de-energized, the main control module controls the magnetic fluid valve to close the release port; and
in a case that the electromagnet is energized with a current in a second direction, the main control module controls the magnetic fluid valve to forcibly close the release port;
wherein the second direction is opposite to the first direction.

11. A control method for an atomization device, the atomization device being the atomization device of claim 1, the atomization device further comprising an atomization assembly communicated with the fluid reservoir through the release port, and the control method comprising:
S1: powering on the atomization device;
S2: detecting whether there is an inhalation action; in response to detecting an inhalation action, controlling the magnetic fluid valve to open the release port to allow e-liquid in the fluid reservoir to enter the atomization assembly through the release port, and controlling the atomization assembly to perform atomization; and after the release port remains open for a third duration, controlling the magnetic fluid valve to close the release port;
S3: continuously detecting whether there is an inhalation action; in response to detecting an inhalation action, controlling the atomization assembly to continue atomization; and in response to detecting no inhalation action, controlling the atomization assembly to stop atomization;
S4: if no inhalation action is detected for a duration reaching a first duration, determining that inhalation ends, and performing step S5;
S5: in response to determining that the remaining number of openings required for the release port after that inhalation ends equals to zero, controlling the atomization device to power off; and in response to determining that the remaining number of openings required for the release port after that inhalation ends is not equal to zero, performing step S6; wherein the remaining number of openings required for the release port after inhalation equals to a post-inhalation cumulative opening count minus the number of times that the release port has already been opened after inhalation, and the post-inhalation cumulative opening count is a preset value; and
S6: controlling the magnetic fluid valve to open the release port for a second duration, then controlling the magnetic fluid valve to close the release port, and incrementing the number of times that the release port has already been opened after that inhalation ends by one; and returning to step S5.

12. The control method of claim 11, wherein, in step S2,
when the magnetic fluid valve is controlled to open the release port, timing begins; and
in response to a timing duration reaching a timeout forced-closure duration, the magnetic fluid valve is controlled to forcibly close the release port;
wherein the timeout forced-closure duration is a preset value.

13. The control method of claim 12, wherein the magnetic field generator is an electromagnet;
when the electromagnet is energized with a current in a first direction, the magnetic movable component moves away from the release port to open the release port; and
when the electromagnet is energized with a current in a second direction, the magnetic movable component moves toward the release port to close the release port, to allow the magnetic fluid valve forcibly close the release port;
wherein the second direction is opposite to the first direction.

14. The control method of claim 13, wherein, in step S2,
the electromagnet is energized with the current in the first direction, and the magnetic movable component moves away from the release port to open the release port; and
after the release port remains open for the third duration, the electromagnet is de-energized, and the magnetic movable component moves toward the release port to close the release port driven by the retainer.

15. The control method of claim 14, wherein, in step S6,
the electromagnet is energized with the current in the first direction, and the magnetic movable component moves away from the release port to open the release port, and
after the release port remains open for the second duration, the electromagnet is de-energized, and the magnetic movable component moves toward the release port to close the release port driven by the retainer.

16. The control method of claim 15, wherein, in step S5,
in response to determining that the remaining number of openings required for the release port after that inhalation ends equals to zero, the electromagnet is de-energized, and the atomization device is controlled to power off; and
in response to determining that the remaining number of openings required for the release port after that inhalation ends is greater than zero, after waiting for the first duration, step S6 is performed.

17. The control method of claim 11, wherein the magnetic field generator is an electromagnet, the retainer is a spring, the magnetic movable component is disposed inside the fluid reservoir, the spring is arranged between the magnetic movable component and an inner wall of the fluid reservoir, and the electromagnet is disposed outside the fluid reservoir;
after the electromagnet is energized with a current in a first direction, the first magnetic pole is attracted to the electromagnet, and the second magnetic pole is subjected to an upward repulsive force, to allow the magnetic movable component to move horizontally away from the release port and compress the spring, so as to open the release port;
after the electromagnet is energized with a current in a second direction, the first magnetic pole is subjected to an upward repulsive force, and the second magnetic pole is attracted to the electromagnet, to allow the magnetic movable component to move horizontally toward the release port, so as to close the release port; and
after the electromagnet is de-energized, the magnetic movable component is pressed against the release port under an action of the spring, so as to close the release port;
wherein the second direction is opposite to the first direction.
